(19) United States
(12) Patent Application Publication
(10) Pub. No.: US 2026/0370911 A1
(43) Pub. Date: Nov. 19, 2026

(54) ARTIFICIAL INTELLIGENCE COMPANION FOR MEDIA CONTENT SIGNALING SYSTEMS

(71) Applicant: DISH Network L.L.C., Englewood, CO (US)

(72) Inventor: Jared Backofen, Colorado Springs, CO (US)

(21) Appl. No.: 19/208,266

(22) Filed: May 14, 2025

(51) Int. Cl. H04N 21/4788; H04L 51/02; H04N 5/14

(52) U.S. Cl. CPC H04N 21/4788; H04L 51/02; H04N 5/147

(57) ABSTRACT

The present disclosure is directed to techniques for processing video signal data by an artificial intelligence (AI) companion bot. The techniques can include causing a user computing device to maintain an active playback session using the video signal data and an active chat session. Using a frame in the set of frames, a computer vision model can be applied to generate a set of scene context tokens. A set of persona context tokens can be generated to define AI companion bot settings, such as traits, personality, and the like. The scene context tokens and persona context tokens can be used to generate a prompt for a trained neural network. The natural-language output generated by the trained neural network can be utilized to generate a response in the active chat session. The response can be attributed to the AI companion bot.

### BACKGROUND

Media content signaling systems (e.g., video streaming systems, audio streaming systems) enable transmission and reception of audiovisual content by various devices. For example, satellite media content signaling systems can transmit television programs through a network of satellites orbiting the Earth. Signals can be received at ground stations, uplinked to satellites, and broadcast back to Earth, where they can be received and decoded by subscriber devices, such as set-top boxes and/or digital video recorders (DVRs) for transmission to connected user devices, such as televisions, smartphones, tablets, laptops, gaming devices, and the like.

Conventional media content signaling systems lack the capability to enable real-time, conversational user interaction with content experts. These systems generally enable one-way communication, where user devices merely receive audiovisual content. As a result, users are unable to engage in interactive conversations with experts who can provide personalized recommendations, answer questions, or offer additional information related to the content being consumed.

### BRIEF DESCRIPTION OF THE DRAWINGS

FIG. 1 illustrates an example distributed system for media content signaling, in accordance with one or more implementations of the present technology.

FIG. 2 illustrates an example environment of operation of a media content signaling system, in accordance with one or more implementations of the present technology.

FIG. 3A illustrates an example signal processing system for implementing an artificial intelligence/machine learning (AI/ML) companion for media content signaling systems, in accordance with one or more implementations of the present technology.

FIGS. 3B-3E illustrate aspects of example graphical user interfaces (GUIs) for implementing an artificial intelligence/machine learning (AI/ML) companion for media content signaling systems, in accordance with one or more implementations of the present technology.

FIG. 4 is a flow diagram illustrating an example method of operation of the AI/ML companion for media content signaling systems, in accordance with one or more embodiments of the present technology.

FIG. 5 is an example AI/ML component stack that can be implemented in connection with the AI/ML companion for media content signaling systems, in accordance with one or more embodiments of the present technology.

FIG. 6 is a component diagram illustrating compute units of an example computing device in an example media content signaling system, in accordance with one or more embodiments of the present technology.

FIG. 7 is a component diagram illustrating a networked arrangement of computing devices in an example media content signaling system, in accordance with one or more embodiments of the present technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to systems, methods, and/or computer-readable media that implement an artificial intelligence/machine learning (AI/ML) companion for media content signaling systems. As used herein, the term “content” can refer to video content provided by streaming services, retrievable from local and/or cloud storage, received via cable, satellite, and/or over-the-air (OTA) broadcast signals, provided by an application, provided by a gaming platform, and so forth. Content can be encoded using suitable video codec(s), such as H.264, H.265, VP9, and/or AV1. The AI companion bot can engage in sophisticated, real-time interactions regarding live or previously recorded content that the bot “watches” along with a user, thereby enhancing the user's viewing experience. The AI companion bot can provide personalized comments, answer questions, and/or offer additional information related to the content being consumed.

To generate operating context for the AI companion bot, the disclosed computing platform can process video signal data and use the processed video signal data in association with user data (e.g., user profile, viewing history, preferences) to generate or capture scene context, persona context, and/or chat context in which a particular instance of an AI companion bot can operate. For example, a particular instance of an AI companion bot can be invoked in connection with a viewing session, playback session, chat session, and the like. For instance, if a user is watching a live sports game, the AI companion bot can provide real-time commentary, statistics, and analysis, while also engaging in a conversation with the user about the game. If a user is watching a movie, the AI companion bot can provide additional information about the film, such as behind-the-scenes facts, actor biographies, and reviews. The AI companion bot can also chat with the user about the film.

Scene context can be generated using multimodal video processing techniques to process video signal data. For example, the platform can use machine learning models capable of processing video inputs, image inputs, and/or metadata inputs. These models can receive feeds that can include video frames, images, and/or metadata, perform object recognition operations on image-based data using computer vision techniques, and/or generate narratives (e.g., scene descriptions, character analyses, plot summaries, dialogue interpretations, background information on historical events or locations depicted in the video, or explanations of technical concepts or jargon used in the video) using the determined objects. For example, the platform can parse out every Nth frame or a sequence of short clips from a particular video and provide these elements to computer vision models for object recognition, thereby allowing for real-time processing and generation of contextual information.

To personalize the AI companion bot, the platform can enable users to define, select, and customize personas (e.g., a comedian, a specific personality) to generate persona context. This allows users to interact with a personalized AI companion bot that aligns with user interests and preferences. For instance, a particular bot can have a tunable set of traits (attributes), such as tone (e.g., formal, informal, sarcastic), language style (e.g., slang, technical, conversational), sense of humor (e.g., dry, witty, slapstick), level of empathy (e.g., sympathetic, neutral, humorous), and expertise (e.g., movie trivia, sports statistics, historical facts). By adjusting these traits, users can create a personalized AI companion bot that provides a unique and engaging experience.

To generate chat context data, the platform can intercept chat sessions associated with video signal data in a particular viewing or playback session and generate text tokens that reflect chat content using natural language processing techniques. The text tokens can reflect the last M user remarks, a summary of a portion of the conversation, or a combination thereof. For example, if a user is watching a live streaming video of a concert on a computing device, the platform can intercept a chat session associated with the video stream, which can be displayed in a window on the screen, and generate text tokens that reflect the conversation. If the user types “I love this song!” in the chat window, the platform can generate a text token that captures the sentiment and content of the remark. Similarly, if a user is watching an OTA broadcast of a sports game on a computing device via a converter device (e.g., digital tuner, streaming device) that streams the broadcast to the computing device, the platform can intercept the chat session associated with the streaming session (e.g., a chat session displayed in a chat app on the computing device) and generate text tokens that reflect the conversation, such as “Did you see that touchdown?” or “The referee made a bad call!”

The AI companion bot can be implemented using various types of neural networks, including but not limited to generative adversarial networks (GANs), transformers, and long short-term memory (LSTM) networks. For example, a GAN can be used to generate text summaries of video content, while a transformer can be used to generate narrative descriptions of the video content. An LSTM network can be used to model the temporal relationships between the video content and the user's interactions, allowing the AI companion bot to generate more personalized and engaging responses. The AI companion bot can also be trained using large datasets of text and video content, allowing it to learn patterns and relationships between different types of media.

To invoke the AI companion bot, the platform can generate model prompts using the scene context, persona context, and/or chat context, and prompt trained machine learning models (e.g., trained neural networks, such as large language models (LLM), LSTM networks, transformers, and/or the like) to instantiate the AI companion bot and cause the AI companion bot to generate remarks related to current or recently (e.g., within the past 1-60 seconds, 1-5 minutes, 1-60 minutes) displayed content. The platform can add the bot as a participant in an existing chat session or create a new chat session in connection with a specific set of video signal data. In some implementations (e.g., in multi-screen viewing mode), a particular version of the bot can be associated with one particular viewing or playback session on a particular screen such that the bot is provided with a particular set of scene, persona, and chat contexts. In some implementations (e.g., in multi-screen viewing mode), the particular version of the bot can be associated with more than one viewing or playback session, such that the bot is provided a set of scene contexts, each corresponding to a particular viewing or playback session. In some implementations (e.g., in a group chat), the user can tag the AI companion bot to ask it questions or direct comments at it, and a parallel conversation pipeline can be instantiated having the AI companion bot respond directly to the user, thereby enabling real-time, conversational interaction.

To generate the scene context, the detected and/or captured images (e.g., images contained in every Nth frame, images detected by detecting a change in video signal data) can be transformed into a set of images and/or corresponding textual data suitable for processing by the AI companion bot. This transformation process can include resizing the images to a uniform resolution, cropping the images to remove unnecessary borders or regions, and/or normalizing the images to adjust brightness, contrast, and color balance. The transformation process can also include binding (programmatically linking) metadata or subsets thereof to the images. For example, the transformation process can include binding closed captions, subtitles, object detection labels, facial recognition data, scene classification labels, metadata about the video content, or audio descriptions to the images.

Further in connection with generating scene context, the platform can generate textual descriptions corresponding to images from video signal data (e.g., by using an image-to-text model, such as a convolutional neural network (CNN) combined with a recurrent neural network (RNN) or transformer, to analyze the visual content of the images and generate descriptive text, such as identifying objects, scenes, and actions depicted in the images, and describing their attributes, relationships, and context). In some implementations, the platform can extract relevant metadata from the video signal data, such as segment metadata (e.g., timing, URL, resolution, bit rate), media content data (e.g., payload in ISO format), and other metadata (e.g., closed captions, subtitles). In some implementations (e.g., where the video signal data originated as a broadcast transmission), the metadata can include broadcast signal metadata. Broadcast signal metadata can include transport stream data, such as program associated tables, program map tables, time and date tables, network information tables, service description tables, event information tables, conditional access tables, application information tables, splice information tables, ad insertion markers, and so forth.

The resulting set of images, textual descriptions corresponding to images, and/or metadata can be used as input to the AI companion bot, which can generate narratives, answer questions, and provide additional information related to the video signal data. By transforming video signal data into a set of images, textual descriptions, and/or metadata, the platform can enable the AI companion bot to interact with the video signal data in a more meaningful and engaging way.

The platform can be used to deploy the AI companion bot in connection with a wide range of video signal data, such as OTA broadcast signals, satellite signals, and/or streaming media signals. Video signal data can include a video stream, which can be thought of as a sequence of digital images displayed in rapid succession to create the illusion of motion. Instead of or in addition to parsing out every Nth frame, a particular set video signal data can be captured and processed to extract specific images based on predefined criteria (triggering events), such as scene changes, character changes, or object detection. For example, the platform can use computer vision techniques to detect changes in the video signal data, such as a change in lighting, color palette, and/or object movement, and capture images at these points.

To detect changes in video signal data, the platform can employ machine learning (ML) models trained on large datasets of video content. For example, convolutional neural networks (CNNs) can be used to analyze the visual features of the video signal data, using techniques such as object detection, scene understanding, and action recognition. Additionally, recurrent neural networks (RNNs) can be used to model the temporal relationships between frames in video signal data, allowing the platform to detect changes in video signal data over time. These ML models can be fine-tuned for specific use cases, such as detecting scene changes in a TV show or detecting object movements in a sports game.

### Distributed System(s) for Media Content Signaling

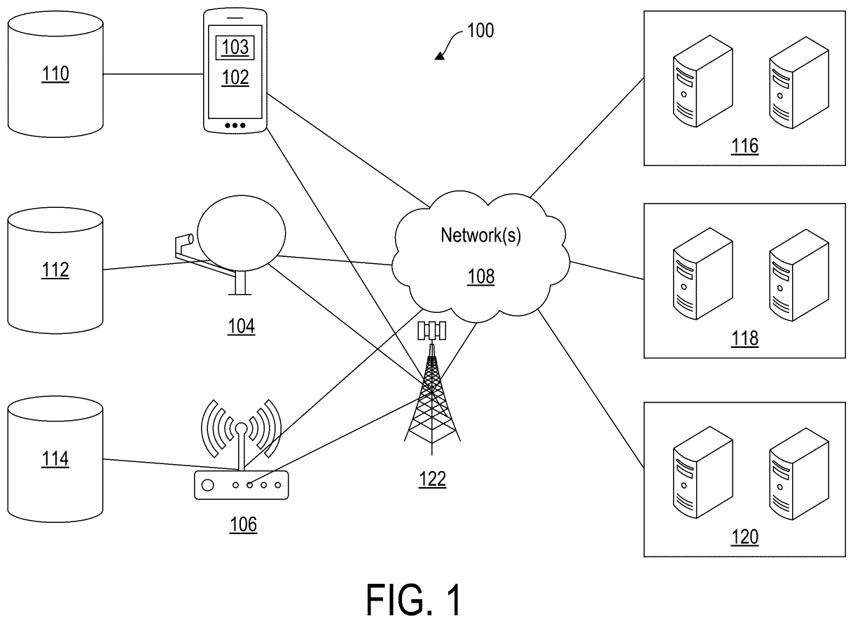

FIG. 1 illustrates an example of a distributed system 100 for media content signaling, in accordance with one or more embodiments of the present technology. The AI companion bot described herein can include a set of hardware components and/or software executables, binaries, compiled executables, and the like, and can be deployed or executable, in whole or in part, at any suitable component of the example system 100.

Example system 100 is a combination of components that interact to form an integrated whole for optimizing storage of recorded media content. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and 106 may be configured to support media content signaling, media selection, media playback, recording, and so forth. In one example, a client device 102 may be a mobile phone, a client device 104 may be a smart over-the-air (OTA) antenna, and a client device 106 may be a broadcast module box (e.g., set-top box). In other example aspects, client device 106 may be a gateway device (e.g., router) that is in communication with sources, such as internet service providers (ISPs), cable networks, or satellite networks. Other possible client devices include but are not limited to smart phones, tablets, personal computers, televisions, augmented reality/virtual reality (AR/VR) devices, and other suitable devices capable of receiving and rendering (e.g., in video form, audio form) a digital signal. In aspects, a client device, such as client devices 102, 104, and 106, may have access to a network from a gateway. In other aspects, client devices 102, 104, and 106, may be equipped to receive data (e.g., instructions from a server) from a gateway. The signals that client devices 102, 104, and 106 may receive may be transmitted from satellite broadcast tower 122. Broadcast tower 122 may also be configured to communicate with network(s) 108, in addition to being able to communicate directly with client devices 102, 104, and 106. In some examples, a client device may be a set-top box that is connected to a display device, such as a television (or a television that may have set-top box circuitry built into the television mainframe).

Client devices 102, 104, and 106 may be configured to run software (e.g., application 103) that allows a user to access the signal processing system described below, record media content, cause playback of media content, view media content, and/or receive media content recommendations. Client devices 102, 104, and 106 may access media content data through the networks. The data may be stored locally on the client device or run remotely via network(s) 108. For example, a client device may receive a signal from broadcast tower 122 containing content data. The signal may include or indicate the content data. The client device may receive the content data and subsequently store the data locally in databases 110, 112, and/or 114. In alternative scenarios, the user requested content data may be transmitted from a client device (e.g., client device 102, 104, and/or 106) via network(s) 108 to be stored remotely on server(s) 116, 118, and/or 120. A user may cause a client device to subsequently access the content data from a local database (110, 112, and/or 114) and/or external database (116, 118, and/or 120), depending on where the content data may be stored.

In some example implementations, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to check for the content data from a channel from an OTA antenna (e.g., antenna 104). A graphical user interface may display on the mobile device 102 the feature and/or notification data. Specifically, at a particular geolocation, the antenna 104 may receive signals from broadcast tower 122. The antenna 104 may then transmit those signals (e.g., for analysis or processing) via network(s) 108. The results of the analysis or processing may then be displayed on mobile device 102 via network(s) 108. In other examples, the results of the analysis or processing may be displayed on a television device connected to a broadcast module box, such as broadcast module box 106.

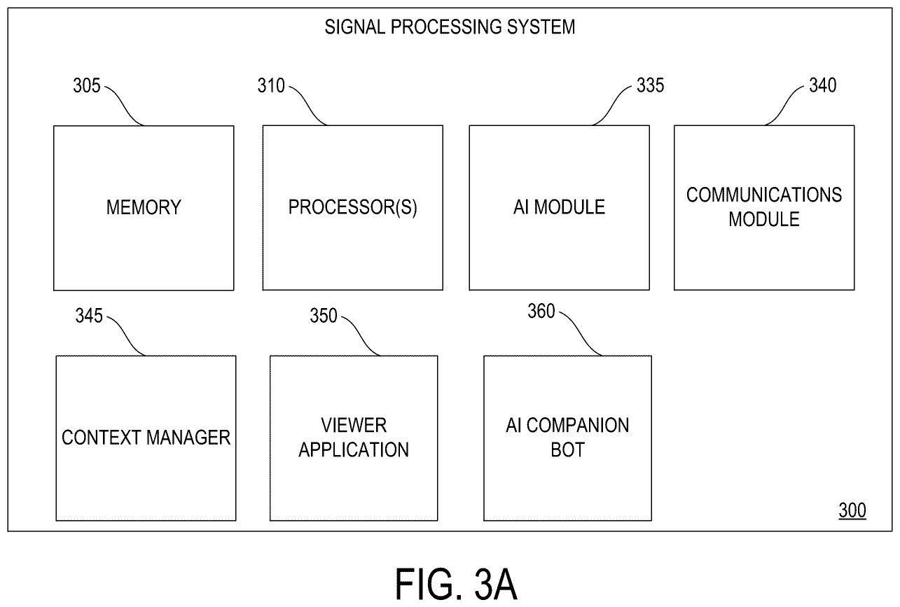

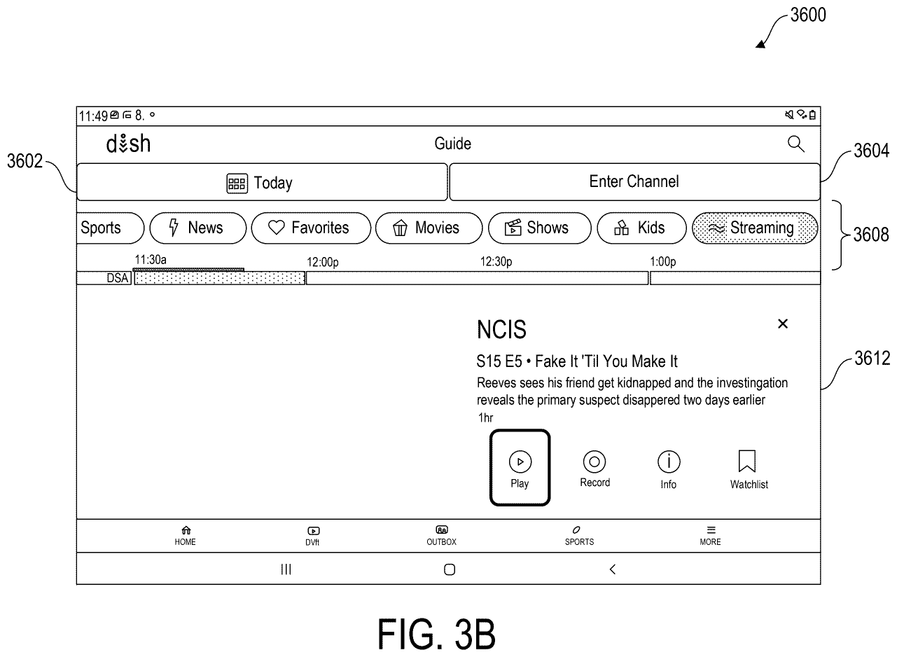

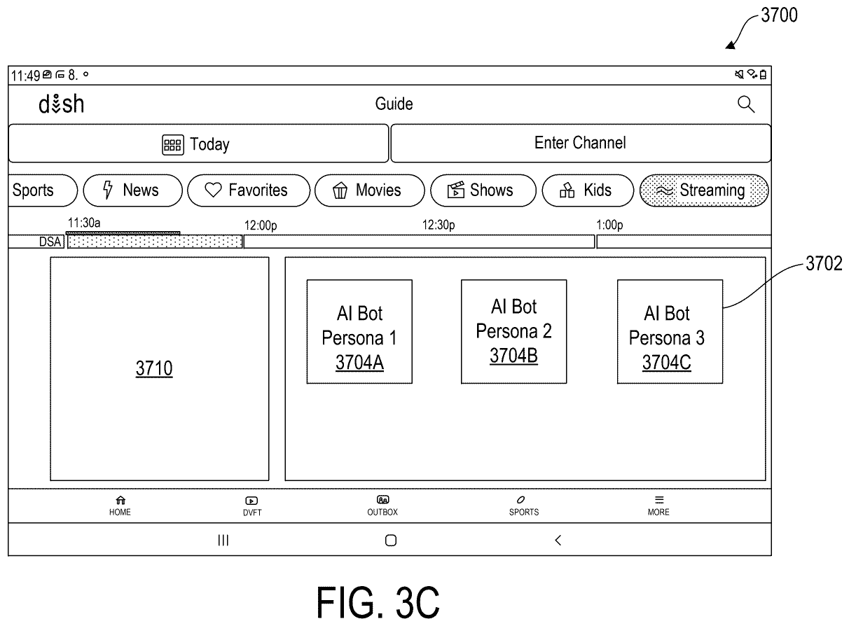

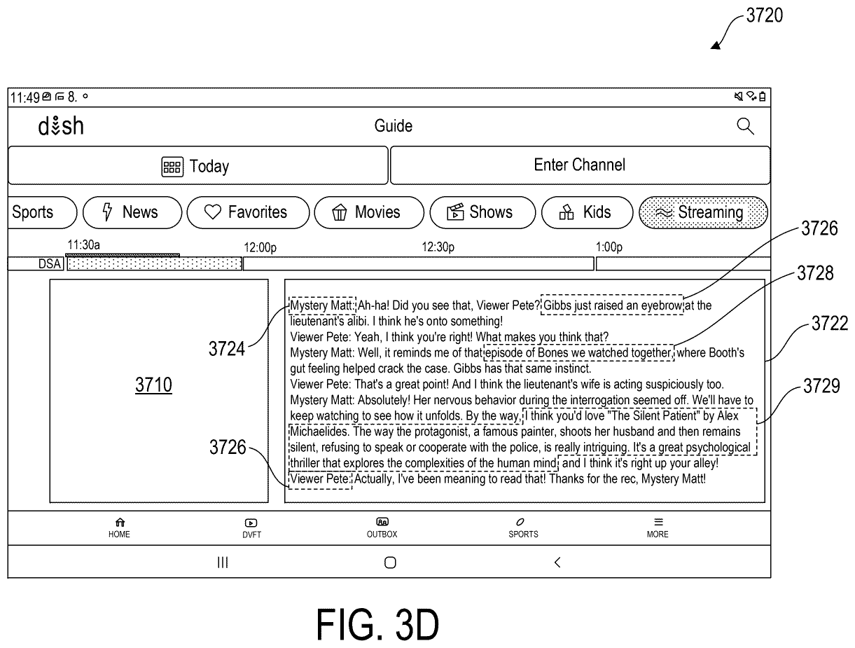

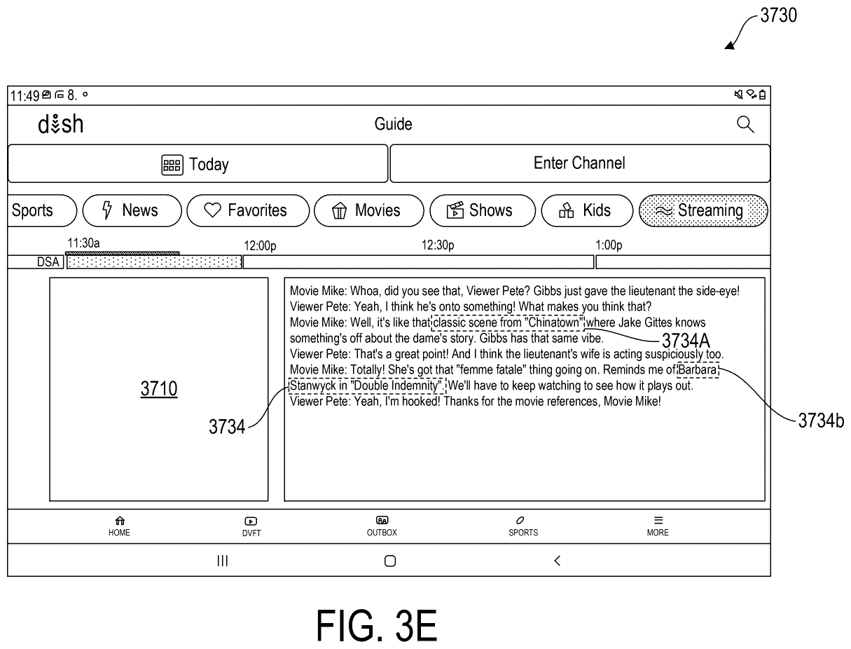

In some implementations, server(s) 116, 118, and/or 120 and/or client devices 102, 104, and/or 106 can be configured to support operations of the AI companion bot as described further herein. For example, the servers and/or devices can include shared or dedicated processing circuitry to implement, at least in part, content signaling operations, such as operations described throughout this document. To that end, various circuits (modules) of the systems described here can include integrated circuits (e.g., application specific integrated circuits (ASICs)) that can include at least one set of neurons and at least one set of synaptic circuits that link the neurons in a neural network. The neurons can include, for example, memory units (e.g., registers), processors units (e.g., microprocessors) and/or input gates. The synaptic circuits can include memory units that can store synaptic weights. According to various implementations, any of the circuits described herein (e.g., various modules of the signal processing system 300 of FIG. 3A) can be implemented as ASICs or can include ASICS.

In some implementations, server(s) 116, 118, and/or 120 are configured to support operations of the AI companion bot as described further herein. For example, the server(s) 116, 118, and/or 120 can be configured to store, include, or access hardware components and/or software executables, binaries, compiled executables, and the like in connection with executing the AI companion bot. The AI companion bot can include various modules, such as natural language processing, computer vision, knowledge retrieval, dialogue management, and personalization. The bot can include a plug-in module to access models, such as language models, computer vision models, or specialized domain models, which can be deployed locally or accessed remotely via an API. In the latter case, the bot can execute an API call and parametrize the call to retrieve specific information or perform a particular task, thereby enabling the bot to leverage a wide range of models and services to provide more accurate and informative responses.

In some examples, databases stored on or accessible via remote servers 116, 118, and 120 may be utilized to assist the signal processing system in providing a user access to the AI companion bot. Such databases may contain a wide range of data, including user data (e.g., user preferences, viewing history, search queries), profile data (e.g., user profiles, account information, subscription details), configuration data (e.g., settings for the AI companion bot, customization options, accessibility features), chat context data (e.g., conversation logs, chat transcripts, user interactions), bot persona context data (e.g., predefined personas, personality traits, tone of voice options, expertise), scene context data (e.g., metadata associated with video content, such as titles, descriptions, genres, timestamps, video content data (e.g., video thumbnails, preview images, video clips), audio data (e.g., audio clips, sound effects, music tracks), textual data (e.g., subtitles, closed captions, transcripts or textual descriptions of audio or video content)), and/or knowledge graph data (e.g., entities, relationships, concepts related to various topics and domains). Such data may be transmitted via network(s) 108 to client devices 102, 104, and/or 106 to assist in executing the AI companion bot operations.

Because broadcast tower 122 and network(s) 108 are configured to communicate with one another, the systems and methods described herein may be able to process video streams from various systems, such as streaming services, local and/or cloud storage, cable, satellite, or over-the-air (OTA) broadcasts. For example, a user may request to watch a live sports event, and the system can route the video stream from the broadcast tower 122 to the client device 102, 104, or 106 via network(s) 108. Alternatively, a user may request to watch a movie from a streaming service, and the system can route the video stream from the streaming service's servers to the client device via network(s) 108. In another example, a user may request to watch a recorded TV show stored on a local DVR, and the system can route the video stream from the DVR to the client device via network(s) 108. Additionally, a user may request to watch a live TV broadcast from a local OTA station, such as a news program, and the system can route the video stream from the broadcast tower 122 to the client device via network(s) 108. Similarly, a user may request to watch a premium cable channel, and the system can route the video stream from the cable provider's servers to the client device via network(s) 108. The routed video stream can then be fed to the AI companion bot, which can analyze the video content, generate metadata, and provide additional information and recommendations to the user.

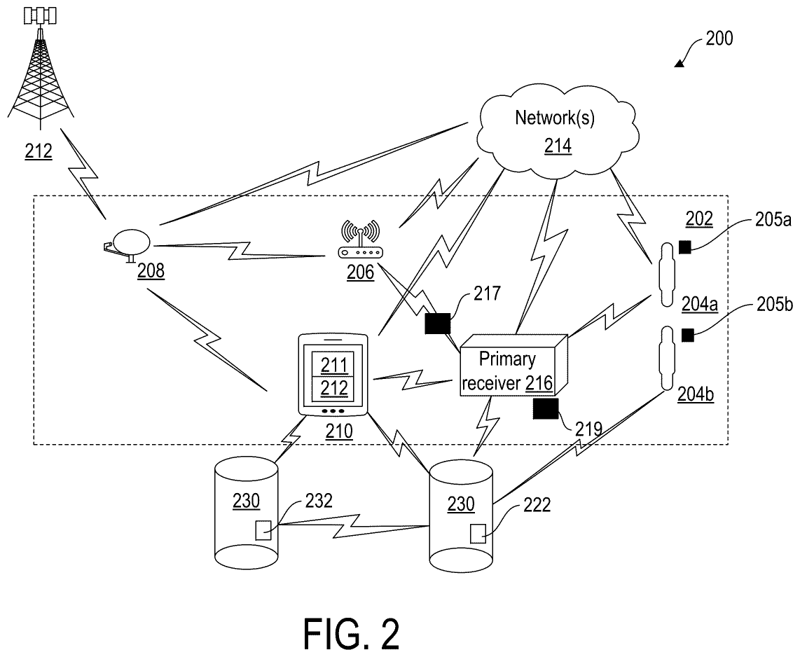

FIG. 2 illustrates an example environment 200 of operation of a media content signaling system, in accordance with one or more implementations of the present technology. In the example environment 200, area 202 may represent a house, a commercial building or an area therein, an industrial building, an apartment, a condo, or any other type of suitable dwelling. Inside area 202 is at least one television (204a, 204b), an OTA box 206 (e.g., broadcast module box, such as a set-top box), an OTA antenna 208 (which, in some implementations, can be combined with the set-top box 208), and a mobile device 210. These devices may be wired or wirelessly configured to communicate with network(s) 214, via a suitable communication protocol or a combination thereof.

The OTA antenna 208 may be configured to receive local broadcast signals from local broadcast tower 212 or satellite broadcast tower. Accordingly, the OTA antenna 208 may route media content signals (e.g., broadcast signals) to the primary receiver 216 and/or television(s) (204a, 204b). The OTA antenna 208 may also receive, generate, and/or route various metadata for broadcast signals, which can provide information about audio and/or video streams. The broadcast signal metadata can include, for example, transport stream data, such as program associated tables, program map tables, time and date tables, network information tables, service description tables, event information tables, conditional access tables, application information tables, splice information tables, ad insertion markers, and so forth.

The primary receiver 216 (e.g., a device that can function as a satellite signal receiver and/or a DVR, NVR, and so forth) may be configured as a hub, gateway, or the like for receiving, transforming, and/or routing various forms of media content signals to user devices, such as television(s) (204(a), 204(b)) and/or mobile device(s) 210. To that end, the primary receiver 216 may receive satellite media content signals via network 214. In some implementations, the primary receiver 216 may include or connect to an OTA adapter device 217, which may act as an additional tuner to a set of tuners of the primary receiver 216 to make broadcast signals accessible to user devices via the primary receiver 216. In some implementations, the primary receiver 216 can be configured to communicate, in a wired or wireless fashion, to one or more auxiliary receivers (205a, 205b) such that more than one user device (e.g., television(s) 204a, 204b) can receive content streams via the primary receiver 216. The content streams can be distinct content streams. To that end, user experience at a particular end device can be configured by electronic commands from the control server 220 using information stored in profile store 222. In some implementations, profile data can include historical information and/or updates regarding user data (e.g., user preferences, viewing history, search queries), profile data (e.g., user profiles, account information, subscription details), configuration data (e.g., settings for the AI companion bot, customization options, accessibility features), chat context data (e.g., conversation logs, chat transcripts, user interactions), bot persona context data (e.g., predefined personas, personality traits, tone of voice options, expertise), scene context data (e.g., metadata associated with video content, such as titles, descriptions, genres, timestamps, video content data (e.g., video thumbnails, preview images, video clips), audio data (e.g., audio clips, sound effects, music tracks), textual data (e.g., subtitles, closed captions, transcripts or textual descriptions of audio or video content)), and/or knowledge graph data (e.g., entities, relationships, concepts related to various topics and domains).

As shown, the primary receiver 216 can send media content signals to one or more mobile devices 210. A particular mobile device 210 can have provided thereto (e.g., as an app, an executable, a plug-in, an applet, or via a browser) an application 211. The application 211 can be configured to receive, decode, and display media content signals.

In some implementations, a particular media content signal can include a consolidated signal stream of OTA broadcast signals, satellite signals, and/or streaming media signals from a service such as Netflix, Prime Video, etc. In such cases, the primary receiver 216 can include circuitry and/or device(s) (e.g., IPTV converter 222 to convert satellite signals) to generate digital (e.g., IP-based) media content signals suitable for transmission via IP-based networks to connected devices such as the mobile device 211. In some implementations, such as when the IPTV converter 222 is bypassed or unavailable, the mobile device 210 can connect to the primary receiver 216 via a suitable wireless connection, such as Wi-Fi or Bluetooth, or via a wired connection, such as Ethernet or USB. In such instances, the application 211 can access and utilize, via the control server 220, connectivity settings (e.g., primary receiver 216 identifier, IP address, login information, user profile identifier) to connect to the primary receiver 216. In some implementations, such as when the primary receiver 216 is out-of-range in relation to the mobile device 210 (e.g., the mobile device 210 is not physically located in the area 202), the application 211 can enable a user to log in, via the control server 220, using a set of login credentials associated with a particular user profile identifier (e.g., rather than using a receiver or another device identifier to authenticate the user).

As shown, the mobile device 210 can receive from the content management server 230, directly or via the primary receiver 216, streaming video signals that serve video files 232 from streaming services, such as Netflix, Prime Video, etc. A particular streaming video signal can be consolidated, using the primary receiver 216 and/or the IPTV converter 219, with a media content signal transmitted or made available to the mobile device 211. For example, a determination can be made, in connection with authenticating user profile and/or receiver based login credentials, or a combination thereof that a user profile indicates the user also has a streaming media account, which can be accessed by the control server 220 and/or primary receiver 216 to retrieve streaming video content.

Accordingly, the application 211 receives a unified streaming content media signal, which can be generated using multiple signals or generated solely using the primary receiver 216. The signal can can include video content encoded according to a suitable video codec, such as H.264, H.265, VP9, and/or AV1. The video content can be transmitted according to a suitable streaming technique, such as an adaptive streaming technique to account for variability in bandwidth of transmission media to mobile device 210. Examples of suitable streaming techniques include Dynamic Adaptive Streaming over HTTP (DASH), HTTP Live Streaming (HLS), and/or Smooth. When a streaming technique is used, the media content can be partitioned into packages and delivered to the mobile device 210 using via a series of HTTP messages. A particular package can include segment metadata (timing, URL, resolution, bit rate) and contain media content data (payload) in suitable format, such as ISO (e.g., MP4), MPEG-2 Transport Stream, or another format.

### Signal Processing System for Implementing the AI/ML Companion

FIG. 3A illustrates an example signal processing system 300 for implementing an AI/ML companion for media content signaling systems, in accordance with one or more implementations of the present technology. FIGS. 3B-3E illustrate aspects of example graphical user interfaces (GUIs) for implementing an artificial intelligence/machine learning (AI/ML) companion for media content signaling systems, in accordance with one or more implementations of the present technology.

The signal processing system 300 (e.g., one or more data processors) is capable of executing algorithms, software routines, and/or instructions based on processing data provided by a variety of sources in connections with performing computer-based operations, such as those described herein. The signal processing system can be a general-purpose computer or a dedicated, special-purpose computer or an arrangement thereof. According to the implementations shown in FIG. 3A, the disclosed system can include memory 305, one or more processors 310, AI module 335, communications module 340, context manager 345, viewer application 350, and AI companion bot 360. Various implementations of the present technology may include some, all, or none of these modules and components, along with other modules, applications, data, and/or components. Some implementations may incorporate two or more of these modules and components into a single module and/or associate a portion of the functionality of one or more of these modules with a different module. Operations of the signal processing system 300 can be performed by a server, a user device, or a combination thereof.

Memory 305 can store instructions for running one or more applications or modules on processor(s) 310. For example, memory 305 could be used in one or more embodiments to house all or some of the instructions needed to execute the functionality of other modules. Generally, memory 305 can include any device, mechanism, or populated data structure used for storing information. In accordance with some embodiments of the present disclosures, memory 305 can encompass, but is not limited to, any type of volatile memory, nonvolatile memory, and dynamic memory. For example, memory 305 can be random access memory, memory storage devices, optical memory devices, magnetic media, floppy disks, magnetic tapes, hard drives, SIMMs, SDRAM, RDRAM, DDR, RAM, SODIMMs, EPROMS, EEPROMs, compact discs, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 305.

In some example aspects, memory 305 may store at least one database containing information associated with the signal processing system 300. The information can include a wide range of data, including user data (e.g., user preferences, viewing history, search queries), profile data (e.g., user profiles, account information, subscription details), configuration data (e.g., settings for the AI companion bot, customization options, accessibility features), chat context data (e.g., conversation logs, chat transcripts, user interactions), bot persona context data (e.g., predefined personas, personality traits, tone of voice options, expertise), scene context data (e.g., metadata associated with video content, such as titles, descriptions, genres, timestamps, video content data (e.g., video thumbnails, preview images, video clips), audio data (e.g., audio clips, sound effects, music tracks), textual data (e.g., subtitles, closed captions, transcripts or textual descriptions of audio or video content)), and/or knowledge graph data (e.g., entities, relationships, concepts related to various topics and domains).

One or more processors 310 can execute instructions stored in memory 305, such as instructions for running one or more applications or modules, including the AI module 335, communications module 340, context manager 345, viewer application 350, and AI companion bot 360.

AI module 335 can provide artificial intelligence (AI) and machine learning (ML) functionality to the signal processing system 300, including processing data from various sources to generate scene context, persona context, and/or chat context for the AI companion bot 360. Additionally, the AI module 335 can implement the AI companion bot's models to enable the bot's personalized and engaging interactions. The AI module 335 can include one or more sequential models, which can be successively applied. For example, a computer vision model can extract (e.g., by context manager 345) an object from a particular frame, and generate an output set that can include an object identifier, object description, object reference location (frame, coordinates, timestamp in a video stream) and so forth. Additional programming logic can be executed (e.g., by context manager 345) to determine or generate synthetic context such as persona context, chat context, and/or viewer history (e.g., in the form of parsed data, tokens, strings, key-value pairs, data retrieved from storage using retrieval-augmented generation (RAG) or another suitable technique, and so forth). The output and/or synthetic values can be provided to a downstream model (e.g., a neural network of the AI companion bot 360) in the form of a prompt, which can cause the AI companion bot to generate responses. As an example, upon detecting a trigger event in a scene, the platform can invoke the AI companion bot. In some implementations, the platform can maintain and periodically reference a set of trigger events that invoke the bot, such as scene detection, object detection, actor detection, time of day, playback time, whether or not an ad is playing, and so forth. For example, the platform can use the trigger events to identify an optimal time for the bot to engage with the user without interrupting playback, negative trigger events to determine when not to engage the bot, and so forth.

Client devices (e.g., personal computers, smart phones, tablets, etc.) may be equipped to access artificial intelligence algorithms of the AI module 335. To that end, a trained model may be deployed to one or more devices. As a specific example, an instance of a trained ML model may be deployed to a server device and/or a client device. The model deployed to a server device may be configured to be used by the client device when, for example, the client device is connected to the internet. Conversely, the model deployed to a client device may be configured to be used by the client device when, for example, the client device is not connected to the internet. In some instances, a client device may not be connected to the internet but still configured to receive satellite signals with connectivity information. In such examples, the model may be locally cached by the client device.

Communications module 340 can handle communication between the signal processing system 300 and external devices or systems, such as one or more client devices, databases, routers, receivers (primary receivers, auxiliary receivers), OTA set-top boxes, controller devices, control servers, content delivery servers, streaming devices, and/or streaming media servers, to exchange data, receive input, or transmit output related to the AI companion bot 360. The communications can employ any suitable type of technology, such as Bluetooth, WiFi, WiMax, Ethernet, cellular, single hop communication, multi-hop communication, Dedicated Short Range Communications (DSRC), or a proprietary communication protocol.

Context manager 345 can manage the generation, updating, and provision of context data to the AI companion bot 360, including scene context, persona context, and/or chat context. The context manager 345 can collect and process data from various sources, such as video signal data, user input, and external data sources, to generate a unified context representation. The context manager 345 can also handle context switching, context updating, and context filtering to ensure that the AI companion bot 360 receives relevant and accurate context data. For example, in multi-screen viewing scenarios, the context manager 345 can switch between different context representations associated with each screen (3610, 3710), updating the context data in real-time as the user interacts with different screens. The context manager 345 can update scene context at various intervals, such as at every N frames or on scene changes. The context manager 345 can also filter out irrelevant context elements, selectively including or excluding specific context elements (e.g., advertisements, scenes with a specific rating or subject matter, scenes featuring a specific character) from the context representation provided to the AI companion bot 360. Furthermore, the context manager 345 can integrate multiple context elements from different sources into a unified context representation, combining scene context from computer vision models, persona context from user profiles, and chat context from natural language processing models to generate a prompt for the AI companion bot 360 that includes all relevant context elements.

Viewer application 350 can provide a user interface for viewing video content, interacting with the AI companion bot 360, and accessing related features or functionality, such as chat windows, video playback controls, or content recommendations. For example, as shown in FIGS. 3A and 3B, an entry point GUI 3600 can be generated for display on a computing device and can include a date selector 3602 and a navigator 3604 to navigate to sets of video signal data (e.g., integrated products 3608, channels, content 3612). For example, the companion bot configuration GUI 3700, shown in FIG. 3C, can include a set of selectable and/or configurable personas 3702.

The AI companion bot 360 can engage in conversations with users, provide information and insights related to video content, and offer personalized interactions based on scene context, persona context, and/or chat context, using natural language processing, machine learning, and other AI technologies.

As shown in FIG. 3C, the AI companion bot 360 can incorporate various personas (3704a, 3704b, 3704c) to engage users. For example, comedians and entertainers like Witty Willie, a fast-talking, joke-cracking bot, Sarcastic Sally, a bot with a sharp tongue and quick wit, and Movie Mike, a film buff bot that dishes out movie trivia and quotes, can provide an entertaining experience. Additionally, pop culture experts like Music Maven, a bot that knows everything about music, TV Tony, a bot that's always up-to-date on the latest TV shows and episodes, and Gaming Guru, a bot that's an expert on all things gaming, can provide users with information and insights on their favorite topics. The AI bot 360 may also incorporate intellectuals and experts, such as History Professor, a bot that's a wealth of knowledge on historical events and figures, Science Sarah, a bot that explains complex scientific concepts in simple terms, and Bookworm Bob, a bot that's always ready to discuss the latest literary releases. Furthermore, quirky and offbeat personalities like Cryptid Chris, a bot that's obsessed with mythical creatures and conspiracy theories, Alien Andy, a bot that's convinced that extraterrestrial life exists and is eager to discuss the evidence, and Mystery Matt, a bot that loves to solve puzzles and play detective, can provide a unique and engaging experience. Finally, sports and fitness enthusiasts like Sports Sam, a bot that's always up-to-date on the latest sports news and scores, Fitness Frank, a bot that's a personal trainer in disguise, always ready with workout tips and advice, and Adventure Andy, a bot that loves to plan and discuss outdoor adventures and activities, can provide users with information and motivation to pursue their fitness goals. These example personas can serve as a foundation for creating a distinctive and captivating chatbot experience, enabling users to interact with a variant of the AI companion bot 360 that aligns with their interests and preferences.

As shown in FIGS. 3D and 3E, after a user 3724 selects a particular persona 3726, and as the user is viewing content and upon occurrence of a trigger event (e.g., upon detecting an active content viewing session, upon detecting the first Nth frame to sample, upon detecting a particular object, scene or another aspect of the video), the platform can invoke a chat session 3722 to enable interaction between the user 3724 and the AI companion bot 360.

The platform can generate a prompt for the neural network invoked by the AI companion bot using scene context, persona context, and/or chat context (e.g., by dynamically generating and/or retrieving from memory the relevant items). To that end, contexts can include sets of tokens included in the prompt as instructions and/or examples in few-shot prompts. In some implementations, the platform can maintain a history of changes in the context of the current chat session, such as a history of changes in scene context, a history of changes in persona context, and/or a history of changes in chat context. For example, the scene context can be updated upon occurrence of trigger events. The persona context can be updated upon detecting a user interaction with the set of selectable and/or configurable personas 3702 and/or upon detecting an in-chat user instruction to tune a particular AI companion bot 360 (e.g., by stating “Be more serious!” or “Imagine you are an expert on [movie genre]”.) The chat context can be updated by processing user statements in the chat session.

The platform can also utilize viewing history to prompt the neural network of the AI companion bot 360. Previously stored viewing history can include the type of content, when the content is recorded, when recorded content is consumed, when recorded content is deleted from the storage device, how long between when a type of content is recorded and when the content is consumed, time of year when a type of content is consumed, watching patterns of the user, or any characteristics that identify the type of content consumed by the user and when the content is stored and consumed. By analyzing the viewing history, the AI companion bot 360 can use a user's behavior of consuming recorded media content to inform user interactions, generate video analogies 3728, generate actor analogies 3734, generate scene analogies 3734a, generate character analogies 3734b, generate recommendations 3729, and the like. In some cases, these items can be user-interactive (e.g., hyperlinks navigable to recommended content, actor information, character information, and so forth). For example, recommendation 3729 can include a hyperlink to a movie. Upon detecting a user interaction with the hyperlink, the platform can update the screen 3710 to cause it to play back the recommended movie, add the movie to a user's queue, generate and display a pop-up menu (e.g., prompting the user to add or rate the movie), or cause another action to be performed.

The operations described herein can be leveraged to generate high-quality training data for the foundation model and/or personalized variants of the models underlying the neural network of the AI companion bot 360. For instance, the capabilities of the context manager 345 particularly configured to generate scene context, persona context, and chat context can be used to create diverse and relevant training examples for the bot's neural network(s), including data points such as video metadata (e.g., titles, descriptions, genres), object detection labels, facial recognition data, scene classification labels, user preferences (e.g., favorite actors, movies, genres), conversation logs (e.g., user input, bot responses), and persona attributes (e.g., tone, language style, sense of humor). In some implementations, the platform's analysis of viewing history can provide training data points such as user watching patterns (e.g., time of day, day of week), content consumption habits (e.g., favorite types of content, frequency of consumption), and engagement metrics (e.g., likes, dislikes, comments). These data points can be used to fine-tune the foundation model or train personalized variants of the model, enabling the development of more accurate and engaging AI companion bots.

In some implementations, the generated data can be used in a feedback loop for incremental training, where user interactions with the bot, such as ratings, feedback, and corrections, are collected and used to update the model in real-time. To preserve user privacy, federated learning techniques can be employed, where the model is trained on decentralized data stored on users' devices, and only model updates are shared with the server. This approach enables the model to learn from a large number of users without compromising their individual privacy.

In some implementations, to minimize the amount of user data that needs to be shared, techniques such as Retrieval-Augmented Generation (RAG) can be used to pull certain user preferences and other relevant information from the viewing history when constructing prompts for the bot, instead of or in addition to causing the neural network(s) learn certain attributes from user interactions. For example, a particular bot can use RAG to retrieve relevant information about the user's viewing history, rather than or in addition to relying on learned preferences from previous interactions. This approach enables the model to provide personalized responses while minimizing the amount of user data that needs to be shared.

### Example Methods of Operation of the AI/ML Companion for Media Content Signaling Systems

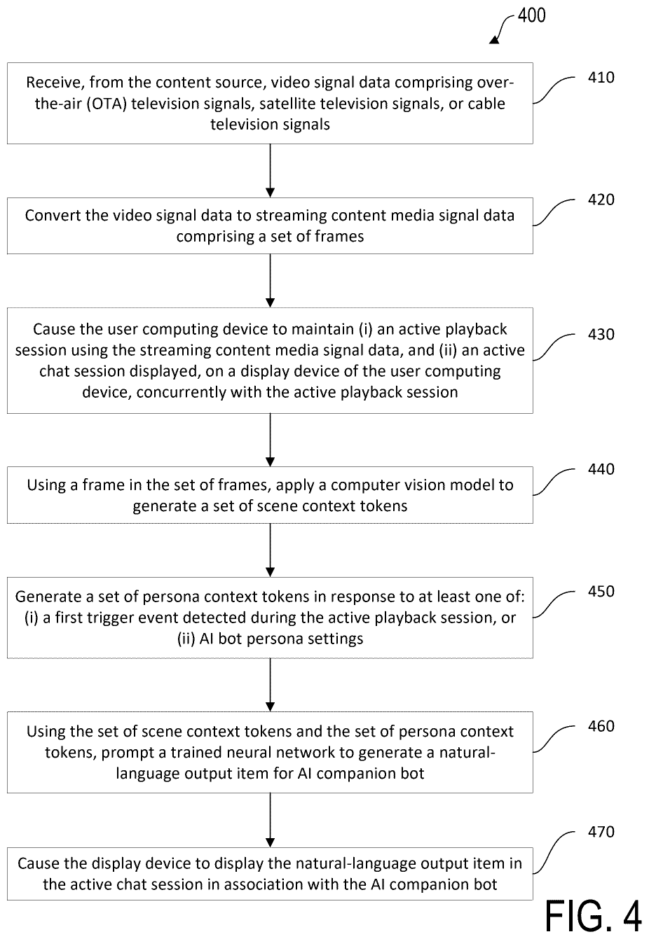

FIG. 4 is a flow diagram 400 illustrating an example method of operation of the AI/ML companion for media content signaling systems, in accordance with one or more embodiments of the present technology. In various implementations, some or all of method 400 can performed locally on the user device or at any other suitable device, such as those described in connection with FIGS. 1 and 2.

At 410, the operations can include (e.g. at a receiver device, end user device, and so forth) receiving, from the content source, video signal data including over-the-air (OTA) television signals, satellite television signals, or cable television signals.

At 420, the operations can include converting the video signal data to streaming content media signal data including a set of frames. For example, signal conversion can be performed using a converter device, which can be included in the receiver device, end user device, or another device, or which can be coupled to such devices.

At 430, the operations can include causing the user computing device to maintain (i) an active playback session using the streaming content media signal data, and (ii) an active chat session displayed, on a display device of the user computing device, concurrently with the active playback session.

At 440, the operations can include, using a frame in the set of frames, applying a computer vision model to generate a set of scene context tokens.

At 450, the operations can include generating a set of persona context tokens in response to at least one of: (i) a first trigger event detected during the active playback session, or (ii) AI bot persona settings.

At 460, the operations can include, using the set of scene context tokens and the set of persona context tokens, prompting a trained neural network to generate a natural-language output item for the AI companion bot.

At 470, the operations can include causing the display device to display the natural-language output item in the active chat session in association with the AI companion bot.

In some aspects, the operations further include dynamically selecting a second frame in the set of frames based on detecting a second trigger event, the second trigger event being one or more of: (i) detecting an Nth frame in the set of frames; (ii) detecting a scene change; (iii) detecting a character change; or (iv) detecting a particular object. The operations can include applying the computer vision model to generate a second set of scene context tokens and, using the second set of scene context tokens, prompting the trained neural network to generate a second natural-language output item.

In some aspects, the operations can include generating the set of scene context tokens by converting an image-based output of the computer vision model to alphanumeric values and using the alphanumeric values to prompt the trained neural network.

In some aspects, the operations can include detecting the first trigger event during the active playback session by parsing a user comment in the active chat session.

In some aspects, the set of persona context tokens includes at least in part a viewer history item retrievably stored in connection with a user account associated with the active chat session.

In some aspects, the operations can include generating a hyperlink to a content item, binding the hyperlink to the natural-language output item displayed in the active chat session, in response to detecting a user interaction with the natural-language output item, generating or receiving second streaming content media signal data corresponding to the content item, and causing the display device to play back the second streaming content media signal data.

### Example AI/ML Architecture

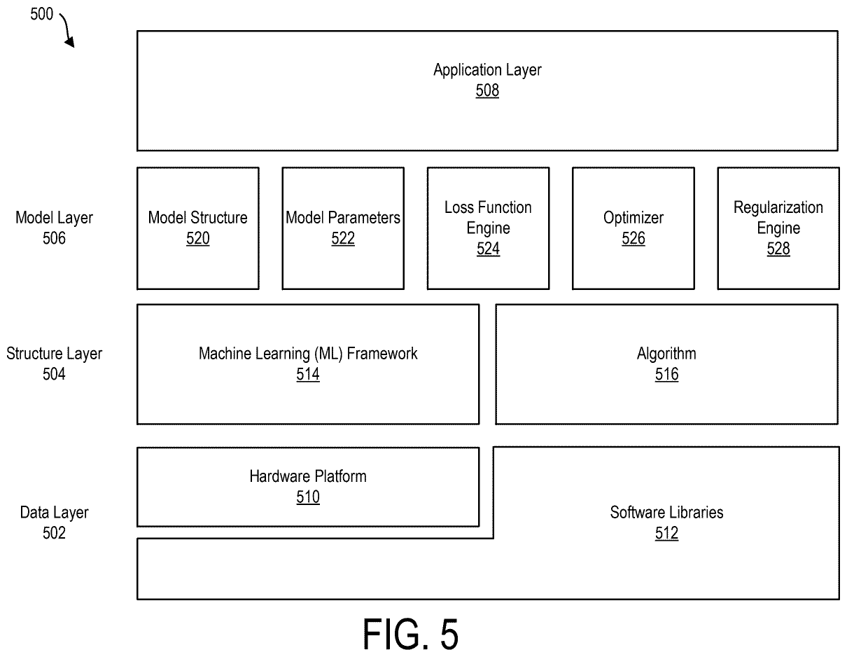

FIG. 5 is an example AI/ML component stack 500 that can be implemented in connection with the AI/ML companion for media content signaling systems, in accordance with one or more embodiments of the present technology. Various components of the AI/ML component stack 500 can be included in and/or invoked by modules of the signal processing system 300, such as the AI module 335, context manager 345, viewer application 350, and/or AI companion bot 360.

As shown, the AI system 500 can include a set of layers, which conceptually organize elements within an example network topology for the AI system's architecture to implement a particular AI model. Generally, an AI model is a computer-executable program implemented by the AI system 500 that analyses data to make predictions. Information can pass through each layer of the AI system 500 to generate outputs for the AI model. The layers can include a data layer 502, a structure layer 504, a model layer 506, and an application layer 508. The algorithm 516 of the structure layer 504 and the model structure 520 and model parameters 522 of the model layer 506 together form an example AI model. The optimizer 526, loss function engine 524, and regularization engine 528 work to refine and optimize the AI model, and the data layer 502 provides resources and support for application of the AI model by the application layer 508.

The data layer 502 acts as the foundation of the AI system 500 by preparing data for the AI model. As shown, the data layer 502 can include two sub-layers: a hardware platform 510 and one or more software libraries 512. The hardware platform 510 can be designed to perform operations for the AI model and include computing resources for storage, memory, logic and networking. The hardware platform 510 can process amounts of data using one or more servers. The servers can perform backend operations such as matrix calculations, parallel calculations, machine learning (ML) training, and the like. Examples of servers used by the hardware platform 510 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors, such as application specific integrated circuits (ASIC). GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 510 can include computing resources, (e.g., servers, memory, etc.) offered by a cloud services provider. The hardware platform 510 can also include computer memory for storing data about the AI model, application of the AI model, and training data for the AI model. The computer memory can be a form of random-access memory (RAM), such as dynamic RAM, static RAM, and non-volatile RAM.

The software libraries 512 can be thought of as suites of data and programming code, including executables, used to control the computing resources of the hardware platform 510. The programming code can include low-level primitives (e.g., fundamental language elements) that form the foundation of one or more low-level programming languages, such that servers of the hardware platform 510 can use the low-level primitives to carry out specific operations. The low-level programming languages do not require much, if any, abstraction from a computing resource's instruction set architecture, allowing them to run quickly with a small memory footprint. Examples of software libraries 512 that can be included in the AI system 500 include INTEL Math Kernel Library, NVIDIA cuDNN, EIGEN, and OpenBLAS.

The structure layer 504 can include an ML framework 514 and an algorithm 516. The ML framework 514 can be thought of as an interface, library, or tool that allows users to build and deploy a particular AI model or models. The ML framework 514 can include an open-source library, an application programming interface (API), a gradient-boosting library, an ensemble method, and/or a deep learning toolkit that work with the layers of the AI system 500 to facilitate development of the AI model. For example, the ML framework 514 can distribute processes for application or training of the AI model across multiple resources in the hardware platform 510. The ML framework 514 can also include a set of components that have the functionality to implement and train a particular AI model and allow users to use pre-built functions and classes to construct and train the AI model. Thus, the ML framework 514 can be used to facilitate data engineering, development, hyperparameter tuning, testing, and training for the AI model. Examples of ML frameworks 514 that can be used in the AI system 500 include Hugging Face Transformers, Stanford CoreNLP, SPACY, TENSORFLOW, PYTORCH, SCIKIT-LEARN, KERAS, LightGBM, RANDOM FOREST, and AMAZON WEB SERVICES, OpenNLP, and GENSIM. In some implementations, more than one framework 514 can be utilized to train and/or invoke specific algorithms 516. For example, any of the module of the signal processing system 300 can train and/or invoke one or more of a particular algorithm 516 (e.g., two distinct algorithms, such as a computer vision model and a neural network).

A particular algorithm 516 can be an organized set of computer-executable operations used to generate output data from a set of input data and can be described using pseudocode. The algorithm 516 can include complex code that allows the computing resources to learn from new input data and create new/modified outputs based on what was learned. In some implementations, the algorithm 516 can build the AI model through being trained while running computing resources of the hardware platform 510. This training allows the algorithm 516 to make predictions or decisions without being explicitly programmed to do so. Once trained, the algorithm 516 can run at the computing resources as part of the AI model to make predictions or decisions, improve computing resource performance, or perform tasks. The algorithm 516 can be trained using supervised learning, unsupervised learning, semi-supervised learning, and/or reinforcement learning, In some implementations, different training techniques can be utilized to train different algorithms 516.

For example, using supervised learning, the algorithm 516 can be trained to learn patterns (e.g., map input data to output data) based on labeled training data. The training data may be labeled by an external user or operator. For instance, a user may collect a set of training data, such as by generating, importing, compiling, or entering entity data, ontology data, or domain-specific data. Furthermore, training data can include structured data generated by various engines of the the signal processing system.

In some implementations, the user may label the training data based on one or more classes and trains the AI model by inputting the training data to the algorithm 516. In various implementations, the structured data can include labels in the form of attribute identifiers, metadata, keys in key-value pairs, or any other suitable form.

The algorithm determines how to label the new data based on the labeled training data. The user can facilitate collection, labeling, and/or input via the ML framework 514. In some instances, the user may convert the training data to a set of feature vectors for input to the algorithm 516. Once trained, the user can test the algorithm 516 on new data to determine if the algorithm 516 is predicting accurate labels for the new data. For example, the user can use cross-validation methods to test the accuracy of the algorithm 516 and retrain the algorithm 516 on new training data if the results of the cross-validation are below an accuracy threshold.

Supervised learning can involve classification and/or regression. Classification techniques involve teaching the algorithm 516 to identify a category of new observations based on training data and are used when input data for the algorithm 516 is discrete. Said differently, when learning through classification techniques, the algorithm 516 receives training data labeled with categories (e.g., classes) and determines how features observed in the training data relate to the categories. Once trained, the algorithm 516 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 516 is continuous. Regression techniques can be used to train the algorithm 516 to predict or forecast relationships between variables. To train the algorithm 516 using regression techniques, a user can select a regression method for estimating the parameters of the model. The user collects and labels training data that is input to the algorithm 516 such that the algorithm 516 is trained to understand the relationship between data features and the dependent variable(s). Once trained, the algorithm 516 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 516 learns patterns from unlabeled training data. In particular, the algorithm 516 is trained to learn hidden patterns and insights of input data, which can be used for data exploration or for generating new data. Here, the algorithm 516 does not have a predefined output, unlike the labels output when the algorithm 516 is trained using supervised learning. Said another way, unsupervised learning is used to train the algorithm 516 to find an underlying structure of a set of data, group the data according to similarities, and represent that set of data in a compressed format.

A few techniques can be used to facilitate model learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques include, for example, density-based methods, hierarchical based methods, partitioning methods, and grid-based methods. In one example, the algorithm 516 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 516 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 516 include factor analysis, item response theory, latent profile analysis, and latent class analysis.

The model layer 506 implements the AI model using data from the data layer 502 and the algorithm 516 and ML framework 514 from the structure layer 504, thus enabling decision-making capabilities of the AI system 500. The model layer 506 includes a model structure 520, model parameters 522, a loss function engine 524, an optimizer 526, and a regularization engine 528.

The model structure 520 describes the architecture of the AI model of the AI system 500. The model structure 520 defines the complexity of the pattern/relationship that the AI model expresses. Examples of structures that can be used as the model structure 520 include decision trees, support vector machines, regression analyses, Bayesian networks, Gaussian processes, genetic algorithms, and artificial neural networks (or, simply, neural networks). The model structure 520 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 520 may include one or more hidden layers of nodes between the input and output layers. The model structure 520 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 522 represent the relationships learned during training and can be used to make predictions and decisions based on input data. The model parameters 522 can weight and bias the nodes and connections of the model structure 520. For instance, when the model structure 520 is a neural network, the model parameters 522 can weight and bias the nodes in each layer of the neural networks, such that the weights determine the strength of the nodes and the biases determine the thresholds for the activation functions of each node. The model parameters 522, in conjunction with the activation functions of the nodes, determine how input data is transformed into desired outputs. The model parameters 522 can be determined and/or altered during training of the algorithm 516.

The loss function engine 524 can determine a loss function, which is a metric used to evaluate the AI model's performance during training. For instance, the loss function engine 524 can measure the difference between a predicted output of the AI model and the actual output of the AI model and is used to guide optimization of the AI model during training to minimize the loss function. The loss function may be presented via the ML framework 514, such that a user can determine whether to retrain or otherwise alter the algorithm 516 if the loss function is over a threshold. In some instances, the algorithm 516 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 526 adjusts the model parameters 522 to minimize the loss function during training of the algorithm 516. In other words, the optimizer 526 uses the loss function generated by the loss function engine 524 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 526 used may be determined based on the type of model structure 520 and the size of data and the computing resources available in the data layer 502.

The regularization engine 528 executes regularization operations. Regularization is a technique that prevents over-and under-fitting of the AI model. Overfitting occurs when the algorithm 516 is overly complex and too adapted to the training data, which can result in poor performance of the AI model. Underfitting occurs when the algorithm 516 is unable to recognize even basic patterns from the training data such that it cannot perform well on training data or on validation data. The optimizer 526 can apply one or more regularization techniques to fit the algorithm 516 to the training data properly, which helps constraint the resulting AI model and improves its ability for generalized application. Examples of regularization techniques include lasso (L1) regularization, ridge (L2) regularization, and elastic (L1 and L2 regularization).

The application layer 508 describes how the AI system 500 is used to solve problem or perform tasks. In an example implementation, the application layer 508 can include the application 103 and/or viewer application 350, which can interact with other elements of the AI system 500 to invoke AI models.

### Example Computing Device

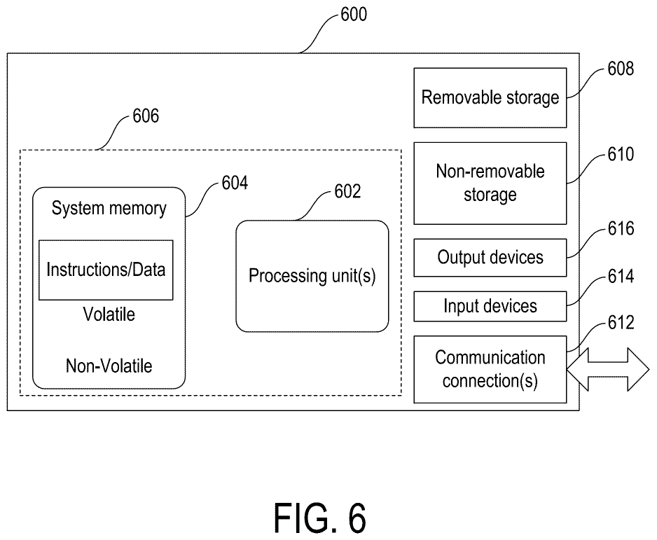

FIG. 6 is a component diagram illustrating compute units of an example computing device 600 in an example media content signaling system, in accordance with one or more embodiments of the present technology. This is only one example of a suitable computing device and is not intended to suggest any limitation as to the scope of use or functionality. Other computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like. In some implementations, components of the computing device 600 are distributed across systems and/or geographical locations.

In its most basic configuration, computing device 600 typically includes at least one processing unit 602 and memory 604. Depending on the exact configuration and type of computing device, memory 604 (storing, among other things, information related to detected devices, compression artifacts, association information, personal gateway settings, and instruction to perform the methods disclosed herein) may be volatile (such as RAM), non-volatile (such as ROM, flash memory, etc.), or some combination of the two. This most basic configuration is illustrated in FIG. 6 by dashed line 606. Further, computing device 600 may also include storage devices (removable 608 and/or non-removable 610) including, but not limited to, magnetic or optical disks or tape. Similarly, computing device 600 may also have input device(s) 614 such as keyboard, mouse, pen, voice input, etc., and/or output device(s) 616 such as a display, speakers, printer, etc. Also included in the environment may be one or more communication connections, 612, such as Bluetooth, WiFi, WiMax, LAN, WAN, point to point, etc.

Operating device 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The computing device 600 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

### Example Networked Computing Environment

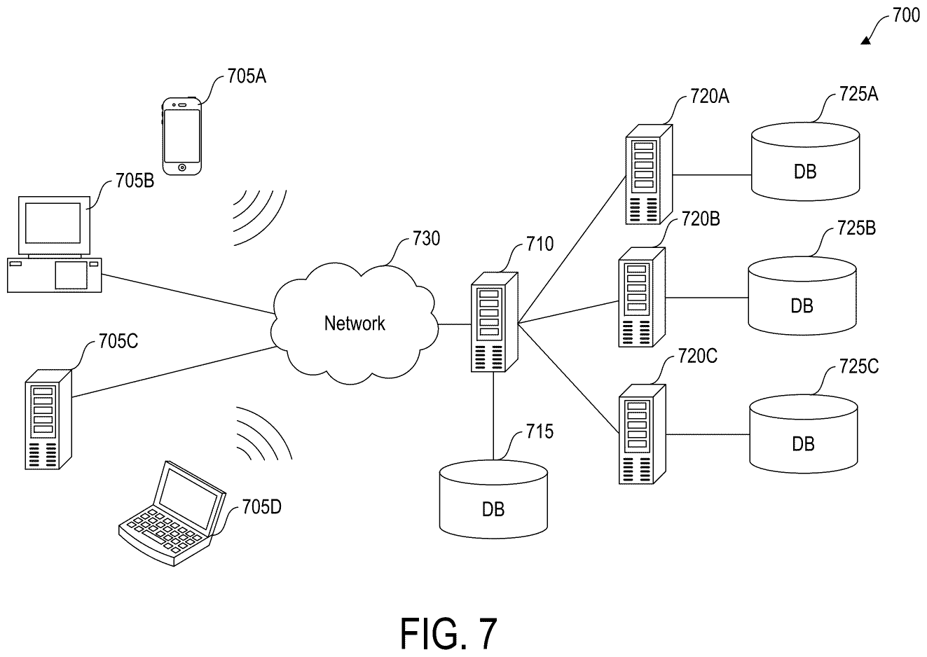

FIG. 7 is a component diagram illustrating a networked arrangement of computing devices in an example media content signaling system, in accordance with one or more embodiments of the present technology. In some implementations, environment 700 includes one or more client computing devices 705A-D, examples of which can host the signal processing system 300. Client computing devices 705 operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server 710 can include a load balancer that distributes requests among a set of servers. In some implementations, server computing devices 710 and 720 comprise computing systems, such as the signal processing system 300. For example, a particular server 710 can include an ASIC configured to perform a particular AI operation (e.g., neural network processing, application of computer vision techniques for scene detection, object recognition, and/or actor recognition, user behavior and preference analytics, visual similarity-based recommendations, and so forth). Although each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database.

Databases 715 and 725 warehouse (e.g., store) information such as training data, ontologies, entity data (e.g., entity, type), domain-specific data, configuration data, model data, weights, vectorized representations of data, graph representations of data, rules and/or logic for detecting similarities, content viewing session management data, and so forth. Although databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN) but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### Conclusion

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims. Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively.

Several implementations of the disclosed technology are described above in reference to the figures. The computing devices on which the described technology may be implemented can include one or more central processing units, memory, user devices (e.g., keyboards and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle specified number of items, or that an item under comparison has a value within a middle specified percentage range.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item, such as A and A; B, B, and C; A, A, B, C, and C; etc.

The above Detailed Description of examples of the technology is not intended to be exhaustive or to limit the technology to the precise form disclosed above. While specific examples for the technology are described above for illustrative purposes, various equivalent modifications are possible within the scope of the technology. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

1. A method for dynamically processing video signal data for use with an AI companion bot, the method comprising:
at a receiver device communicatively coupled to a content source and a user computing device,
receiving, from the content source, video signal data comprising over-the-air (OTA) television signals, satellite television signals, or cable television signals;
converting the video signal data to streaming content media signal data comprising a set of frames;
causing the user computing device to maintain (i) an active playback session using the streaming content media signal data, and (ii) an active chat session displayed, on a display device of the user computing device, concurrently with the active playback session;
using a frame in the set of frames, applying a computer vision model to generate a set of scene context tokens;
generating a set of AI companion bot persona context tokens in response to at least one of: (i) a first trigger event detected during the active playback session, or (ii) AI bot persona settings, wherein the set of AI companion bot persona context tokens indicate a selected set of traits for the AI companion bot;
using an operating context for the AI companion bot, prompting a trained neural network to generate a natural-language output item for the AI companion bot, wherein the operating context for the AI companion bot comprises the set of scene context tokens and the set of AI companion bot persona context tokens; and
causing the display device to display the natural-language output item in the active chat session in association with the AI companion bot.

2. The method of claim 1, wherein converting the video signal data to streaming content media signal data is performed using a converter device removably coupled to the receiver device.

3. The method of claim 1, wherein the frame is a first frame and the natural-language output item is a first natural-language output item, the method further comprising maintaining a current operating context for the AI companion bot by:
dynamically selecting a second frame in the set of frames based on detecting a second trigger event, the second trigger event being one or more of: (i) detecting an Nth frame in the set of frames; (ii) detecting a scene change; (iii) detecting a character change; or (iv) detecting a particular object;
applying the computer vision model to generate a second set of scene context tokens; and
using the second set of scene context tokens, prompting the trained neural network to generate a second natural-language output item.

4. The method of claim 1, the method further comprising:
generating the set of scene context tokens by converting an image-based output of the computer vision model to alphanumeric values; and
using the alphanumeric values to prompt the trained neural network.

5. The method of claim 1, further comprising:
detecting the first trigger event during the active playback session by parsing a user comment in the active chat session.

6. The method of claim 1, wherein the operating context for the AI companion bot comprises at least in part a viewer history item retrievably stored in connection with a user account associated with the active chat session.

7. The method of claim 1, further comprising:
generating a hyperlink to a content item;
binding the hyperlink to the natural-language output item displayed in the active chat session; and
in response to detecting a user interaction with the natural-language output item, generating or receiving second streaming content media signal data corresponding to the content item; and
causing the display device to play back the second streaming content media signal data.

8. One or more non-transitory computer-readable media having computer-executable instructions stored thereon that, when executed by at least one processor of a computing system, cause the computing system to perform operations for dynamically processing video signal data for use with an AI companion bot, the operations comprising:
at a receiver device communicatively coupled to a content source and a user computing device,
receiving, from the content source, video signal data comprising over-the-air (OTA) television signals, satellite television signals, or cable television signals;
converting the video signal data to streaming content media signal data comprising a set of frames;
causing the user computing device to maintain (i) an active playback session using the streaming content media signal data, and (ii) an active chat session displayed, on a display device of the user computing device, concurrently with the active playback session;
using a frame in the set of frames, applying a computer vision model to generate a set of scene context tokens;
generating a set of AI companion bot persona context tokens in response to at least one of: (i) a first trigger event detected during the active playback session, or (ii) AI bot persona settings, wherein the set of AI companion bot persona context tokens indicate a selected set of traits for the AI companion bot;
using an operating context for the AI companion bot, prompting a trained neural network to generate a natural-language output item for the AI companion bot, wherein the operating context for the AI companion bot comprises the set of scene context tokens and the set of AI companion bot persona context tokens; and
causing the display device to display the natural-language output item in the active chat session in association with the AI companion bot.

9. The non-transitory computer-readable media of claim 8, wherein converting the video signal data to streaming content media signal data is performed using a converter device removably coupled to the receiver device.

10. The non-transitory computer-readable media of claim 8, wherein the frame is a first frame and the natural-language output item is a first natural-language output item, the operations further comprising maintaining a current operating context for the AI companion bot by:
dynamically selecting a second frame in the set of frames based on detecting a second trigger event, the second trigger event being one or more of: (i) detecting an Nth frame in the set of frames; (ii) detecting a scene change; (iii) detecting a character change; or (iv) detecting a particular object;
applying the computer vision model to generate a second set of scene context tokens; and
using the second set of scene context tokens, prompting the trained neural network to generate a second natural-language output item.

11. The non-transitory computer-readable media of claim 8, the operations further comprising:
generating the set of scene context tokens by converting an image-based output of the computer vision model to alphanumeric values; and
using the alphanumeric values to prompt the trained neural network.

12. The non-transitory computer-readable media of claim 8, the operations further comprising:
detecting the first trigger event during the active playback session by parsing a user comment in the active chat session.

13. The non-transitory computer-readable media of claim 8, wherein the operating context for the AI companion bot comprises at least in part a viewer history item retrievably stored in connection with a user account associated with the active chat session.

14. The non-transitory computer-readable media of claim 8, the operations further comprising:
generating a hyperlink to a content item;
binding the hyperlink to the natural-language output item displayed in the active chat session; and
in response to detecting a user interaction with the natural-language output item, generating or receiving second streaming content media signal data corresponding to the content item; and
causing the display device to play back the second streaming content media signal data.

15. A computing system comprising at least one processor, and a memory having computer-executable instructions stored thereon that, when executed by the at least one processor, cause the computing system to perform operations for dynamically processing video signal data for use with an AI companion bot, the operations comprising:
at a receiver device communicatively coupled to a content source and a user computing device,
receive, from the content source, video signal data comprising over-the-air (OTA) television signals, satellite television signals, or cable television signals;
convert the video signal data to streaming content media signal data comprising a set of frames;
cause the user computing device to maintain (i) an active playback session using the streaming content media signal data, and (ii) an active chat session displayed, on a display device of the user computing device, concurrently with the active playback session;
using a frame in the set of frames, apply a computer vision model to generate a set of scene context tokens;
generate a set of AI companion bot persona context tokens in response to at least one of: (i) a first trigger event detected during the active playback session, or (ii) AI bot persona settings, wherein the set of AI companion bot persona context tokens indicate a selected set of traits for the AI companion bot;
using an operating context for the AI companion bot, prompt a trained neural network to generate a natural-language output item for the AI companion bot, wherein the operating context for the AI companion bot comprises the set of scene context tokens and the set of AI companion bot persona context tokens; and
cause the display device to display the natural-language output item in the active chat session in association with the AI companion bot.

16. The system of claim 15, wherein converting the video signal data to streaming content media signal data is performed using a converter device removably coupled to the receiver device.

17. The system of claim 15, wherein the frame is a first frame and the natural-language output item is a first natural-language output item, and wherein maintaining a current operating context for the AI companion bot is performed by performing operations to:
dynamically select a second frame in the set of frames based on detecting a second trigger event, the second trigger event being one or more of: (i) detecting an Nth frame in the set of frames; (ii) detecting a scene change; (iii) detecting a character change; or (iv) detecting a particular object;
apply the computer vision model to generate a second set of scene context tokens; and
using the second set of scene context tokens, prompt the trained neural network to generate a second natural-language output item.

18. The system of claim 15, the operations further comprising:
generate the set of scene context tokens by converting an image-based output of the computer vision model to alphanumeric values; and
use the alphanumeric values to prompt the trained neural network.

19. The system of claim 15, the operations further comprising:
detect the first trigger event during the active playback session by parsing a user comment in the active chat session.

20. The system of claim 15, the operations further comprising:
generate a hyperlink to a content item;
bind the hyperlink to the natural-language output item displayed in the active chat session; and
in response to detecting a user interaction with the natural-language output item, generate or receive second streaming content media signal data corresponding to the content item; and
cause the display device to play back the second streaming content media signal data.
